(19) United States
(12) Patent Application Publication
(10) Pub. No.: US 2026/0189296 A1
(43) Pub. Date: Jul. 2, 2026

(54) WIRELESS COMMUNICATION SYSTEM AND DOPPLER SHIFT ESTIMATION METHOD

(71) Applicant: NTT, Inc., Tokyo (JP)

(72) Inventors: Tomoya KAGEYAMA, Musashino-shi (JP); Kazumitsu SAKAMOTO, Musashino-shi (JP); Yosuke FUJINO, Musashino-shi (JP); Kiyohiko ITOKAWA, Musashino-shi (JP); Yasuyoshi KOJIMA, Musashino-shi (JP); Daisuke GOTO, Musashino-shi (JP)

(73) Assignee: NTT, Inc., Tokyo (JP)

(21) Appl. No.: 18/729,782

(22) PCT Filed: Jan. 21, 2022
(86) PCT No.: PCT/JP2022/002168

§ 371 Date: Jul. 17, 2024

(51) Int. Cl. H04B 7/155

(52) U.S. Cl. CPC H04B 7/155

(57) ABSTRACT

There is provided a wireless communication system in which a plurality of transmission devices include a transmission unit that transmits a wireless signal, the wireless communication device includes one or more antennas that receive the wireless signals transmitted from the plurality of transmission devices, and a waveform transmission unit that transmits waveform data indicating a waveform of a reception signal received by the one or more antennas to the reception device, the reception device includes a reception unit that receives the waveform data transmitted by the wireless communication device, a signal storage unit that stores the reception signal indicated by the waveform data received by the reception unit, an information conversion unit that converts the reception signal for a predetermined period stored in the signal storage unit into a two-dimensional or higher information matrix, a frame detection unit that detects a head and a frame length of a plurality of frames included in the reception signal for a predetermined period by performing feature amount detection in the two-dimensional or higher information matrix, and an estimation unit that estimates a Doppler shift amount of at least each frame based on the two-dimensional or higher information matrix and a head and a frame length of the plurality of frames.

### TECHNICAL FIELD

The present invention relates to a wireless communication system and a Doppler shift amount estimation method.

### BACKGROUND ART

With the development of Internet of Things (IoT) technology, installing IoT terminals including various sensors in various places has been studied. The IoT terminals may be installed in places where it is difficult to install a base station, such as a buoy or a ship on the sea or a mountainous area. In view of this, a system has been proposed in which data collected by IoT terminals installed in various places is relayed to a base station installed on the ground via a relay device mounted on a low earth orbit satellite.

In the satellite sensing platform, a different Doppler shift occurs in the signal transmitted from each IoT terminal according to the position of the IoT terminal. Therefore, signals subjected to different Doppler shifts in the frame arrive at the reception antenna of the low earth orbit satellite at random time. Similarly, the preamble also receives a different Doppler shift for each IoT terminal, and time synchronization processing based on correlation with a known signal becomes difficult. Non Patent Literature 1 proposes Doppler frequency shift (DFS) estimation using a preamble and a postamble.

### CITATION LIST

### Non Patent Literature

Non Patent Literature 1: “Data-Aided Doppler frequency shift estimation and compensation for UAVs”, IEEE Internet of things journal., vol. 1. no. 1. January 2020.

### SUMMARY OF INVENTION

### Technical Problem

However, the overhead is a problem in a communication scheme with a low data rate. Therefore, conventionally, there is a problem that the Doppler shift amount cannot be estimated without performing correlation detection or the like on a plurality of signals subjected to different Doppler shifts.

In view of the above circumstances, an object of the present invention is to provide a technology by which a signal frame can be detected and a Doppler shift amount can be estimated without generating an overhead due to insertion of a dedicated preamble for time synchronization for a plurality of signals subjected to different Doppler shifts.

### Solution to Problem

According to an aspect of the present invention, there is provided a wireless communication system comprising a plurality of transmission devices, a moving wireless communication device, and a reception device, in which the plurality of transmission devices include a transmission unit configured to transmit a wireless signal, the wireless communication device includes one or more antennas configured to receive wireless signals transmitted from the plurality of transmission devices, and a waveform transmission unit configured to transmit waveform data indicating a waveform of a reception signal received by the one or more antennas to the reception device, the reception device includes a reception unit configured to receive the waveform data transmitted by the wireless communication device, a signal storage unit configured to store reception signals indicated by the waveform data received by the reception unit, an information conversion unit configured to convert the reception signals for a predetermined period stored in the signal storage unit into a two-dimensional or higher information matrix, a frame detection unit configured to detect a head and a frame length of a plurality of frames included in the reception signals for the predetermined period by performing feature amount detection in the two-dimensional or higher information matrix, and an estimation unit configured to estimate a Doppler shift amount of at least each frame based on the two-dimensional or higher information matrix and a head and a frame length of the plurality of frames detected by the frame detection unit.

According to another aspect of the present invention, there is provided a Doppler shift amount estimation method, which is a frame detection method in a wireless communication system including a plurality of transmission devices, a moving wireless communication device, and a reception device, in which each of the plurality of transmission devices transmits a wireless signal, the wireless communication device transmits, to the reception device, waveform data indicating a waveform of a reception signal received by one or more antennas that receive wireless signals transmitted from the plurality of transmission devices, the reception device receives the waveform data transmitted by the wireless communication device, the reception device converts the reception signals for a predetermined period stored in the signal storage unit that stores the reception signals indicating the received waveform data, into a two-dimensional or higher information matrix, the reception device detects a head and a frame length of a plurality of frames included in the reception signals for the predetermined period by performing feature amount detection in the two-dimensional or higher information matrix, and a Doppler shift amount of at least each frame is estimated based on the two-dimensional or higher information matrix and a head and a frame length of the plurality of detected frames.

### Advantageous Effects of Invention

According to the present invention, it is possible to detect a signal frame and estimate a Doppler shift amount without generating an overhead due to insertion of a dedicated preamble for time synchronization with respect to a plurality of signals subjected to different Doppler shifts.

### BRIEF DESCRIPTION OF DRAWINGS

FIG. 1 is a configuration diagram of a wireless communication system according to an embodiment.

FIG. 2 is a diagram illustrating an example of received waveform information obtained by a base station.

FIG. 3 is a diagram showing an example of a spectrogram based on time and frequency.

FIG. 4 is a sequence diagram illustrating a flow of reception processing of the wireless communication system according to the embodiment.

### DESCRIPTION OF EMBODIMENTS

Hereinafter, an embodiment of the present invention will be described with reference to the drawings.

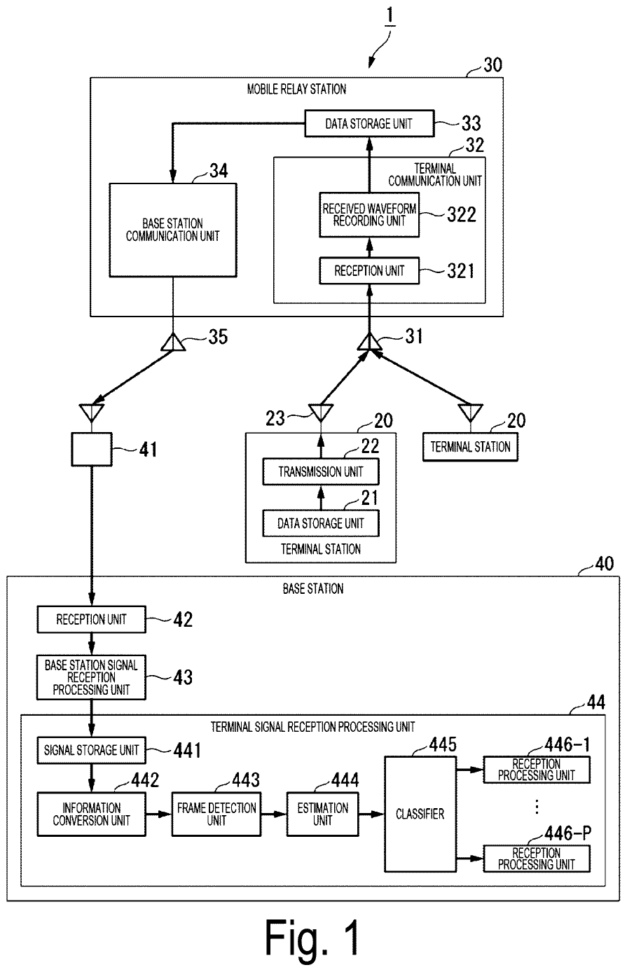

FIG. 1 is a configuration diagram of a wireless communication system 1 according to an embodiment. The wireless communication system 1 includes a plurality of terminal stations 20, a mobile relay station 30, and a base station 40. The number of each of the terminal station 20, the mobile relay station 30, and the base stations 40 included in the wireless communication system 1 is randomly selected. It is assumed that the number of terminal stations 20 is large.

Each terminal station 20 collects data such as environmental data detected by a sensor and wirelessly transmits the collected data to the mobile relay station 30. For example, in a case where an instruction for a transmission timing is given from the mobile relay station 30, the terminal station 20 wirelessly transmits the collected data to the mobile relay station 30 at the transmission timing for which the instruction is given. The terminal station 20 is, for example, an Internet of Things (IoT) terminal. The terminal station 20 is an aspect of a transmission device.

The mobile relay station 30 is an example of a wireless communication device which is mounted on a moving object and of which an area where communication is possible moves with the lapse of time. The mobile relay station 30 of the present embodiment is provided in a low earth orbit (LEO) satellite. The LEO satellite has an altitude of 2000 km or less and travels through the sky around the earth in approximately 1.5 hours per orbit. The terminal station 20 and the base station 40 are installed on the earth such as on the ground or on the sea. Hereinafter, a wireless signal transmitted from the terminal station 20 to the mobile relay station 30 will be referred to as a terminal uplink signal, and a signal transmitted from the mobile relay station 30 to the base station 40 will be referred to as a base station downlink signal.

Since the mobile relay station 30 mounted on the LEO satellite performs communication while moving at a high speed, a time during which each terminal station 20 or the base station 40 can communicate with the mobile relay station 30 is limited. Specifically, seen from the ground, the mobile relay station 30 passes through the sky in about several minutes. Therefore, the terminal station 20 collects and stores data such as environmental data detected by the sensor. The terminal station 20 transmits a terminal uplink signal in which the collected data is set at a timing at which communication with the mobile relay station 30 is possible. The mobile relay station 30 receives the terminal uplink signal transmitted from each of the plurality of terminal stations 20 while moving in the sky above the earth. The mobile relay station 30 accumulates data received from each of the terminal stations 20 via the terminal uplink signals and wirelessly transmits the accumulated data to the base station 40 via base station downlink signals at a timing at which the mobile relay station 30 can communicate with the base station 40. The base station 40 acquires the data collected by the terminal stations 20 from the received base station downlink signals.

The mobile relay station 30 includes antennas used for wireless communication with the terminal stations 20 and antennas used for wireless communication with the base station 40. Therefore, the mobile relay station 30 can perform wireless communication with the terminal stations 20 and wireless communication with the base station 40 in parallel.

The mobile relay station may be, for example, a relay station mounted on an unmanned aerial vehicle such as a geostationary satellite, drone, or high altitude platform station (HAPS). However, a relay station mounted on a geostationary satellite has a wide coverage area (footprint) on the ground, but has an extremely small link budget with respect to IoT terminals installed on the ground because the altitude thereof is high. Meanwhile, a relay station mounted on a drone or HAPS has a high link budget, but has a narrow coverage area.

Further, the drone needs a battery, and the HAPS needs a solar panel. In the present embodiment, the mobile relay station 30 is mounted on the LEO satellite. Thus, the link budget falls within a limit, and, in addition, the LEO satellite has no air resistance and has low fuel consumption because the LEO satellite travels around the outside of the atmosphere. Further, the footprint is large, as compared with a case where the relay station is mounted on the drone or HAPS.

The base station 40 acquires a plurality of reception signals subjected to different Doppler shifts by transmission from each terminal station 20 to the mobile relay station 30 from the mobile relay station 30, and detects the head timing of the plurality of reception signals and estimates the Doppler shift amount without performing correlation detection or the like on the plurality of acquired reception signals. Further, the base station 40 collectively detects signals of a plurality of communication schemes based on the base station downlink signal transmitted from the mobile relay station 30. The base station 40 is an aspect of a reception device.

The terminal station 20 and the base station 40 are installed at specific positions on the earth such as on the ground or on the sea.

A configuration of each device will be described.

The terminal station 20 includes a data storage unit 21, a transmission unit 22, and one or a plurality of antennas 23. FIG. 1 illustrates a case where the terminal station 20 includes one antenna 23. The data storage unit 21 stores environmental data detected by the sensor. The transmission unit 22 communicates with the mobile relay station 30. The transmission unit 22 reads the environmental data from the data storage unit 21 as terminal transmitted data, and wirelessly transmits a terminal uplink signal in which the read terminal transmitted data is set from the antenna 23.

The transmission unit 22 transmits a signal by low power wide area (LPWA), for example. LPWA includes LoRaWAN (registered trademark), Sigfox (registered trademark), Long Term Evolution for Machines (LTE-M), Narrow Band (NB)-IoT, and the like, but any wireless communication scheme may be used. The transmission unit 22 may perform transmission with another terminal station 20 by time division multiplexing, orthogonal frequency division multiplexing (OFDM), or the like. The transmission unit 22 may perform beam formation of signals transmitted from the plurality of antennas 23 according to a method determined in advance in the wireless communication scheme to be used.

The mobile relay station 30 includes one or a plurality of antennas 31, a terminal communication unit 32, a data storage unit 33, a base station communication unit 34, and one or a plurality of antennas 35. FIG. 1 illustrates a case where the mobile relay station 30 includes one antenna 31 and one antenna 35.

The terminal communication unit 32 performs wireless communication with the terminal station 20. The terminal communication unit 32 includes a reception unit 321 and a received waveform recording unit 322. The reception unit 321 receives a terminal uplink signal through the antenna 31. The received waveform recording unit 322 samples a received waveform of the terminal uplink signal received by the reception unit 321, and generates waveform data indicating a value obtained by the sampling. The received waveform recording unit 322 writes, in the data storage unit 33, the reception time of the terminal uplink signal in the antenna 31 and received waveform information in which the generated waveform data is set. The data storage unit 33 stores the received waveform information written by the received waveform recording unit 322.

The base station communication unit 34 transmits the received waveform information to the base station 40 by a base station downlink signal of any wireless communication scheme.

The base station 40 includes an antenna 41, a reception unit 42, a base station signal reception processing unit 43, and a terminal signal reception processing unit 44. The reception unit 42 converts the base station downlink signal received by the antenna 41 into an electrical signal. The base station signal reception processing unit 43 demodulates and decodes the reception signal converted into the electrical signal by the reception unit 42 to obtain received waveform information. The base station signal reception processing unit 43 outputs the received waveform information to the terminal signal reception processing unit 44.

The terminal signal reception processing unit 44 includes a signal storage unit 441, an information conversion unit 442, a frame detection unit 443, an estimation unit 444, a classifier 445, and a plurality of reception processing units 446-1 to 446-P (P is an integer of 2 or more).

The signal storage unit 441 stores the received waveform information obtained by the base station signal reception processing unit 43.

The information conversion unit 442 converts a plurality of pieces of received waveform information stored in the signal storage unit 441 acquired during a time length (for example, 5 or 10 times the frame length) sufficiently longer than the frame length of the reception signal into a two-dimensional or higher information matrix. For example, the two-dimensional or higher information matrix is a spectrogram based on time and frequency.

The frame detection unit 443 detects one or more frames subjected to the Doppler shift on the spectrogram acquired by the information conversion unit 442 using a feature amount detection technology. Here, the frame is a frame included in the received waveform information, and is terminal transmitted data of the terminal station 20. For example, the frame detection unit 443 detects a frame subjected to a Doppler shift by line segment detection as a feature amount detection technology. An existing technology is used for line segment detection.

Furthermore, the frame detection unit 443 detects the head timing and the frame length of the frame based on one or more frames detected in the spectrogram. The head timing of the frame represents the time of the head of the detected frame. The frame length represents the length of the detected frame.

The estimation unit 444 estimates the Doppler shift amount based on one or more frames detected in the spectrogram by the frame detection unit 443. The Doppler shift amount indicates the amount of the Doppler shift generated in the detected frame. The estimation unit 444 outputs information of the head timing and the frame length of the frame detected by the frame detection unit 443 to the classifier 445 in addition to each piece of the received waveform information and the Doppler shift amount.

The classifier 445 classifies each piece of the received waveform information for each wireless communication scheme based on each piece of the received waveform information and the estimation result output from the estimation unit 444. For example, the classifier 445 estimates the wireless communication scheme of each piece of the received waveform information by using the frame length detected by the frame detection unit 443, the occupied bandwidth obtained from the received waveform information, and the used channel, and classifies each piece of the received waveform information for each wireless communication scheme.

The reception processing units 446-1 to 446-P acquire terminal transmitted data by performing the reception processing according to the wireless communication scheme used for transmission by the terminal station 20. Each of the reception processing units 446 performs reception processing of different wireless communication schemes. Each reception processing unit 446 acquires terminal transmitted data by performing reception processing based on a corresponding wireless communication scheme on a frame classified and input by the classifier 445.

The reception processing performed by the reception processing units 446-1 to 446-P includes processing of demodulating and decoding waveform data. Here, the reception processing units 446-1 to 446-P may perform demodulation after performing processing of compensating for the Doppler shift of the terminal uplink signal received by the antenna 31 of the mobile relay station 30. The Doppler shift received by the terminal uplink signal received by the antenna 31 of the mobile relay station 30 may be estimated from the occupied bandwidth obtained from the received waveform information, may be estimated from the slope of the result of line segment detection, or may be calculated in advance based on the position of the terminal station 20 and the orbit information of the LEO equipped with the mobile relay station 30. In a case where the Doppler shift is calculated based on the LEO orbit information, the LEO orbit information is information related to the orbit of the LEO satellite equipped with the mobile relay station 30, and is, for example, information by which the position, speed, moving direction, and the like of the LEO satellite can be obtained at any time.

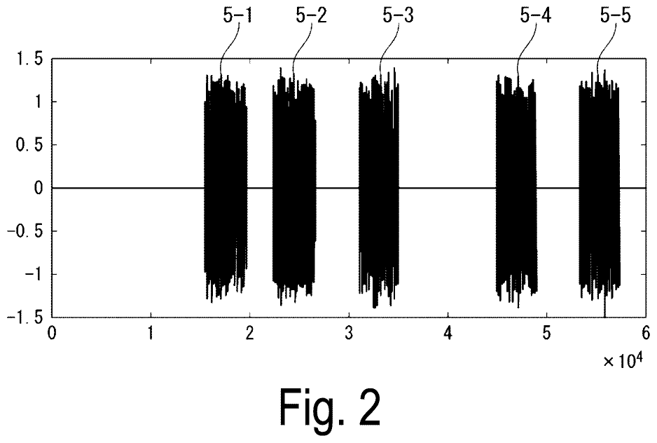

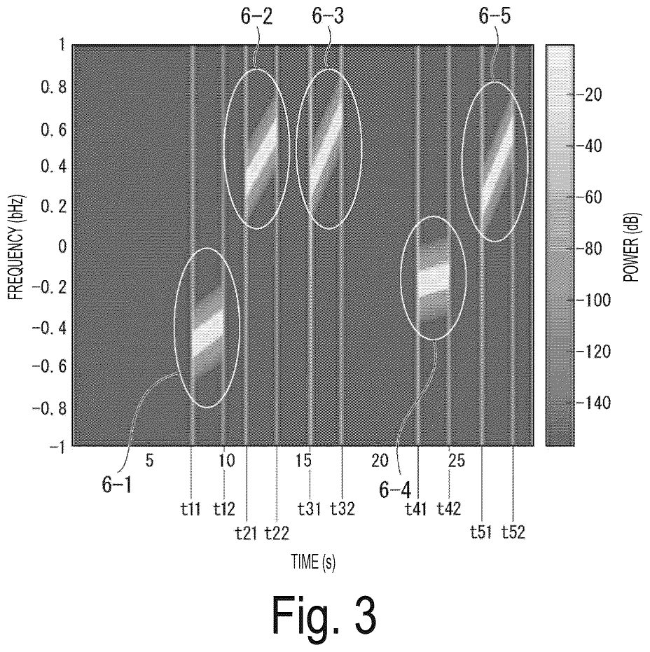

Next, processing performed by the base station 40 will be described with reference to FIGS. 2 and 3. FIG. 2 is a diagram illustrating an example of received waveform information obtained by the base station 40, and FIG. 3 is a diagram illustrating an example of a spectrogram based on time and frequency. FIG. 2 illustrates received waveform information of terminal uplink signals transmitted from each of the five terminal stations 20. The information conversion unit 442 of the base station 40 acquires the spectrogram based on the time and the frequency illustrated in FIG. 3 using the plurality of pieces of received waveform information stored in the signal storage unit 441 acquired during the time length sufficiently longer than the frame length of one reception signal.

Thereafter, the frame detection unit 443 of the base station 40 detects a frame by line segment detection in the spectrogram illustrated in FIG. 3. As a result, the frame detection unit 443 of the base station 40 detects frames surrounded by circles 6-1 to 6-5 in FIG. 3. In the following description, a frame surrounded by the circle 6-1 is referred to as a first frame, a frame surrounded by the circle 6-2 is referred to as a second frame, a frame surrounded by the circle 6-3 is referred to as a third frame, a frame surrounded by the circle 6-4 is referred to as a fourth frame, and a frame surrounded by the circle 6-5 is referred to as a fifth frame.

The frame detection unit 443 of the base station 40 detects the head timing and the frame length of the frame based on each of the detected first to fifth frames. The estimation unit 444 of the base station 40 estimates the Doppler shift amount based on each of the detected first to fifth frames. In the example shown in FIG. 3, the frame detection unit 443 detects the head timing of the first frame as time t11, detects the head timing of the second frame as time t21, detects the head timing of the third frame as time t31, detects the head timing of the fourth frame as time t41, and detects the head timing of the fifth frame as time t51.

Further, the frame detection unit 443 detects the start point and the end point of the line segment of the first frame, and estimates the difference between the detected start point and end point as the frame length. In the example illustrated in FIG. 3, the frame detection unit 443 detects the start point “t11” and the end point “t12” of the line segment of the first frame, and estimates the difference (t11−t12) as the frame length. The frame detection unit 443 estimates the frame length of the second to fifth frames in the same manner.

For example, in the example illustrated in FIG. 3, the frame detection unit 443 detects the start point “t21” and the end point “t22” of the line segment of the second frame, and estimates the difference (t21−t22) as the frame length. For example, in the example illustrated in FIG. 3, the frame detection unit 443 detects the start point “t31” and the end point “t32” of the line segment of the third frame, and estimates the difference (t31−t32) as the frame length. In the example illustrated in FIG. 3, the frame detection unit 443 detects the start point “t41” and the end point “t42” of the line segment of the fourth frame, and estimates the difference (t41−t42) as the frame length. For example, in the example illustrated in FIG. 3, the frame detection unit 443 detects the start point “t51” and the end point “t52” of the line segment of the fifth frame, and estimates the difference (t51−t52) as the frame length.

The estimation unit 444 obtains the inclination of the line segment of the first frame and estimates the obtained slope as the Doppler shift amount of the first frame. The estimation unit 444 estimates the Doppler shift amount of each frame in the second to fifth frames by a similar method.

As described above, in the present embodiment, the head timing of the frame, the frame length, the modulation scheme, and the Doppler shift amount can be estimated by a simple method.

An operation of the wireless communication system 1 will be described.

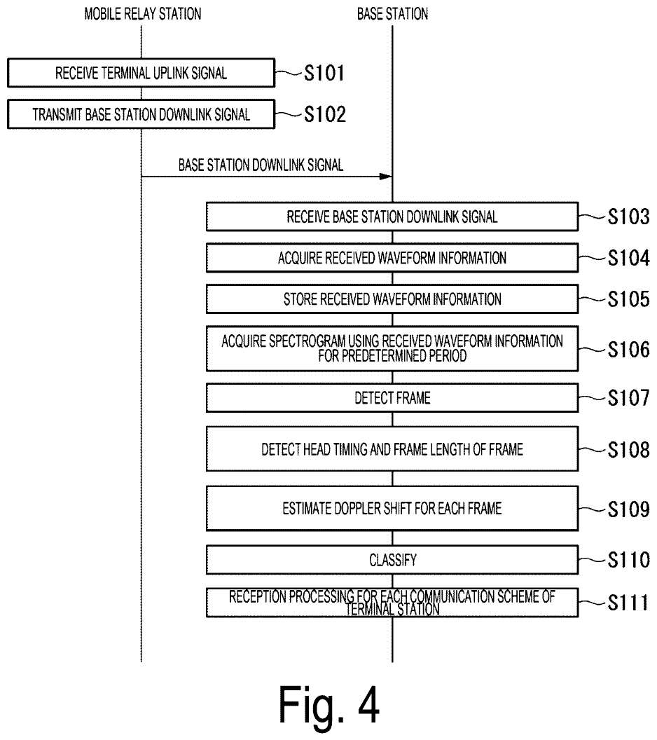

FIG. 4 is a sequence diagram illustrating a flow of reception processing of the wireless communication system 1 according to the embodiment.

The mobile relay station 30 receives the terminal uplink signal transmitted from the terminal station 20 (step S101). The mobile relay station 30 acquires the received waveform information based on the received terminal uplink signal, and writes the acquired received waveform information in the data storage unit 33. The base station communication unit 34 transmits the received waveform information to the base station 40 by a base station downlink signal of any wireless communication scheme (step S102).

The reception unit 42 of the base station 40 receives the base station downlink signal via the antenna 41 (step S103). The reception unit 42 converts the received base station downlink signal into an electrical signal. The base station signal reception processing unit 43 demodulates and decodes the reception signal converted into the electrical signal by the reception unit 42 to obtain received waveform information (step S104). The base station signal reception processing unit 43 stores the received waveform information in the signal storage unit 441 (step S105). The processing from step S101 to step S105 is executed each time the terminal uplink signal is transmitted from the terminal station 20 to the mobile relay station 30 and communication between the mobile relay station 30 and the base station 40 becomes possible.

The information conversion unit 442 acquires a spectrogram based on time and frequency by using the received waveform information for a predetermined period stored in the signal storage unit 441 (step S106). The information conversion unit 442 outputs each piece of received waveform information and the acquired spectrogram to the frame detection unit 443.

The frame detection unit 443 detects one or more frames subjected to the Doppler shift on the spectrogram acquired by the information conversion unit 442 using a feature amount detection technology (step S107).

Based on the one or more detected frames and the spectrogram, the frame detection unit 443 detects the head timing and the frame length of the frame in each of the one or more detected frames (step S108). The frame detection unit 443 outputs each piece of received waveform information, a spectrogram, and information on the one or more detected frames (for example, the head timing and the frame length of the frame) to the estimation unit 444. The estimation unit 444 estimates the Doppler shift amount based on one or more frames and the spectrogram (step S109). The estimation unit 444 outputs information on one or more frames and an estimation result (for example, the Doppler shift amount) to the classifier 445 in association with each piece of the received waveform information.

The classifier 445 receives each piece of the received waveform information output from the estimation unit 444 and information on one or more frames as inputs. The classifier 445 classifies each piece of the received waveform information based on each piece of the input received waveform information and the information on one or more frames, and outputs each piece of the received waveform information to the reception processing units 446-1 to 446-P according to the classification result (step S109). For example, the received waveform information corresponding to the terminal uplink signal transmitted from the terminal station 20 to the mobile relay station 30 by the first wireless communication scheme is output to the reception processing unit 446 (for example, the reception processing unit 446-1) that performs reception processing according to the first wireless communication scheme, and the received waveform information corresponding to the terminal uplink signal transmitted from the terminal station 20 to the mobile relay station 30 by the second wireless communication scheme is output to the reception processing unit 446 (for example, the reception processing unit 446-2) that performs reception processing according to the second wireless communication scheme.

Each of the reception processing units 446 acquires terminal transmitted data by demodulating and decoding the input received waveform information (step S110). As a result, the base station 40 collectively detects signal frames of a plurality of wireless communication schemes regardless of the sequence of the preamble and the modulation scheme.

According to the wireless communication system 1 configured as described above, it is possible to detect a plurality of signals subjected to different Doppler shifts by a simple method. Specifically, in the wireless communication system 1, the received waveform information based on the base station downlink signal transmitted from the mobile relay station 30 is stored, the received waveform information for a predetermined period is converted into a two-dimensional or higher information matrix, the feature amount detection is performed in the two-dimensional or higher information matrix to detect the head timing and the frame length of the plurality of frames included in the received waveform information for the predetermined period, and the Doppler shift amount of at least each frame is estimated based on the two-dimensional or higher information matrix and the head timing and the frame length of the plurality of frames. Therefore, it is possible to estimate the Doppler shift amount without generating an overhead for a plurality of signals subjected to different Doppler shifts.

Furthermore, in the wireless communication system 1, a plurality of frames included in the reception signal for a predetermined period are detected by performing line segment detection in the two-dimensional or higher information matrix. Therefore, it is possible to collectively detect signals of a plurality of wireless communication schemes regardless of the sequence of the preamble and the modulation scheme.

Hereinafter, a modification example of the wireless communication system 1 will be described.

The mobile relay station 30 may include a plurality of antennas 31, and receive a terminal uplink signal transmitted from the terminal station 20, and the base station 40 may include a plurality of antennas 41, and be configured to receive a base station downlink signal transmitted from the mobile relay station 30. In such a configuration, the base station 40 detects the antenna, corrects the shift of the head timing due to the arrival time difference from the detection result, and then performs the MIMO equivalent processing.

In the above embodiments, there has been described a case where a moving object equipped with the mobile relay station is the LEO satellite. However, the moving object may be another flying object flying in the sky, such as a geostationary satellite, drone, or HAPS.

A part or the entirety of the processing performed by the base station 40 in the above-described embodiments may be implemented by a computer. In that case, a program for implementing this function may be recorded in a computer-readable recording medium, and the program recorded in the recording medium may be read and executed by a computer system to implement the functions. Note that the “computer system” mentioned herein includes an OS and hardware such as peripheral devices. In addition, the “computer-readable recording medium” refers to a portable medium such as a flexible disk, a magneto-optical disc, a ROM, or a CD-ROM, or a storage device such as a hard disk built in a computer system.

Furthermore, the “computer-readable recording medium” may include a medium that dynamically holds a program for a short time, such as a communication line in a case where the program is transmitted via a network such as the Internet or a communication line such as a telephone line, and a medium that holds a program for a certain period of time, such as a volatile memory inside a computer system serving as a server or a client in that case. Also, the above program may be for implementing some of the functions described above, may be for implementing the functions described above in combination with programs already recorded in the computer system, or may be implemented with a programmable logic device such as a field programmable gate array (FPGA).

Although the embodiments of the present invention have been described above in detail with reference to the drawings, the specific configuration is not limited to the embodiments, and includes design and the like without departing from the spirit of the present invention.

### INDUSTRIAL APPLICABILITY

The present invention can be applied to a technology for performing communication with a moving object equipped with a mobile relay station.

### REFERENCE SIGNS LIST

1 Wireless communication system
20 Terminal station
21 Data storage unit
22 Transmission unit
30 Mobile relay station
40 Base station
31 Antenna
32 Terminal communication unit
33 Data storage unit
34 Base station communication unit
35 Antenna
41 Antenna
42 Reception unit
43 Base station signal reception processing unit
44 Terminal signal reception processing unit
441 Signal storage unit
442 Information conversion unit
443 Frame detection unit
444 Estimation unit
445 Classifier
446-1 to 446-P Reception processing unit

1. A wireless communication system comprising a plurality of transmission devices, a moving wireless communication device, and a reception device, wherein
the plurality of transmission devices include a transmitter configured to transmit a wireless signal,
the wireless communication device includes
one or more antennas configured to receive wireless signals transmitted from the plurality of transmission devices, and
a waveform transmitter configured to transmit waveform data indicating a waveform of reception signal received by the one or more antennas to the reception device,
the reception device includes
a receiver configured to receive the waveform data transmitted by the wireless communication device,
a signal storage configured to store reception signals indicated by the waveform data received by the receiver,
an information converter configured to convert the reception signals for a predetermined period stored in the signal storage into a two-dimensional or higher information matrix,
a frame detector configured to detect a head and a frame length of a plurality of frames included in the reception signals for the predetermined period by performing feature amount detection in the two-dimensional or higher information matrix, and
an estimator configured to estimate a Doppler shift amount of at least each frame based on the two-dimensional or higher information matrix and a head and a frame length of the plurality of frames detected by the frame detector.

2. The wireless communication system according to claim 1, wherein
the frame detector detects the plurality of frames included in the reception signals for the predetermined period by performing line segment detection in the two-dimensional or higher information matrix.

3. The wireless communication system according to claim 1, further comprising:
a classifier configured to classify the plurality of frames detected by the frame detector for each wireless communication scheme based on a detected frame length, an occupied bandwidth obtained by the reception signals, and a used channel; and
a plurality of reception processors configured to perform reception processing according to each wireless communication scheme.

4. A Doppler shift amount estimation method, which is a frame detection method in a wireless communication system including a plurality of transmission devices, a moving wireless communication device, and a reception device, wherein
each of the plurality of transmission devices transmits a wireless signal,
the wireless communication device transmits, to the reception device, waveform data indicating a waveform of a reception signal received by one or more antennas that receive wireless signals transmitted from the plurality of transmission devices,
the reception device receives the waveform data transmitted by the wireless communication device,
the reception device converts the reception signals for a predetermined period stored in the signal storage that stores the reception signals indicating the received waveform data, into a two-dimensional or higher information matrix,
the reception device detects a head and a frame length of a plurality of frames included in the reception signals for the predetermined period by performing feature amount detection in the two-dimensional or higher information matrix, and
a Doppler shift amount of at least each frame is estimated based on the two-dimensional or higher information matrix and a head and a frame length of the plurality of detected frames.
